(19) United States
(12) Patent Application Publication
(10) Pub. No.: US 2026/0363213 A1
(43) Pub. Date: Nov. 19, 2026

(54) CATTLE CONFORMATION EVALUATION SYSTEM

(71) Applicant: Holstein Association USA, Inc., Brattleboro, VT (US)

(72) Inventors: Jeffrey Bewley, Elizabethtown, KY (US); Daniel Lau, Lexington, KY (US); Kaixuan Zhao, Luoyang, Henan Province (CN)

(21) Appl. No.: 19/212,116

(22) Filed: May 19, 2025

(51) Int. Cl. A01K 29/00; G06V 40/10

(52) U.S. Cl. CPC A01K 29/005; G06V 40/10

(57) ABSTRACT

A system may include a set of cameras configured to capture real-time images of a type of livestock passing by the set of cameras. The system may include an electronic processor communicatively connected to the set of cameras and configured to receive identification data associated with an individual livestock. The electronic processor may be configured to process the real-time images to extract key points of the individual livestock. The electronic processor may be configured to determine a trait of the individual livestock using the key points. The electronic processor may be configured to obtain a baseline set of traits associated with the type of livestock. The electronic processor may be configured to generate an electronic file associated with the individual livestock when the trait determined deviates from a corresponding one of the baseline set of traits by a predetermined amount.

### FIELD

Aspects described herein relate to, among other things, a method and system for collecting and evaluating cattle conformation.

### SUMMARY

A relationship exists between dairy cattle conformation (the physical traits of a cow) and production and longevity of the cow. Measuring conformation traits through subjective visual assessment has provided data for genetic improvement of dairy animals. Thus far, this data has been collected by people observing cows directly. Advancements in machine vision technologies and techniques have provided the opportunity to explore this technique and to quantify these traits objectively and in high throughput scenarios on large dairies.

In some aspects, the techniques described herein relate to a system for evaluating cattle conformation, the system including: a set of cameras configured to capture real-time images of a type of livestock passing by the set of cameras; and an electronic processor communicatively connected to the set of cameras and configured to: receive identification data associated with an individual livestock; process the real-time images to extract key points of the individual livestock; determine a trait of the individual livestock using the key points; obtain a baseline set of traits associated with the type of livestock; and generate an electronic file associated with the individual livestock when the trait determined deviates from a corresponding one of the baseline set of traits by a predetermined amount.

In some aspects, the techniques described herein relate to a method of evaluating cattle conformation, the method including: capturing real-time images with a set of cameras, the real-time images including a type of livestock passing by the set of cameras; receiving identification data associated with an individual livestock at an electronic processor; processing the real-time images to extract key points of the individual livestock; determining a trait of the individual livestock using the key points; obtaining a baseline set of traits associated with the type of livestock; and generating an electronic file associated with the individual livestock when the trait determined deviates from a corresponding one of the baseline set of traits by a predetermined amount.

Other aspects will become apparent by consideration of the detailed description and accompanying drawings.

### BRIEF DESCRIPTION OF THE DRAWINGS

FIG. 1 is a schematic of a cattle conformation evaluation system according to one example.

FIG. 2 is a top view of the system from FIG. 1.

FIG. 3 is a schematic of the system from FIG. 1 illustrating hardware components according to one example.

FIG. 4 is a flowchart of an example algorithm implemented by an electronic processor of the system from FIG. 3 according to one example.

FIG. 5A is an exemplary depth image of a cow having passed through the cattle conformation evaluation system.

FIG. 5B is an exemplary mask image after morphological processing has been applied to the exemplary top-view depth image of FIG. 5A.

FIG. 5C is the mask image from FIG. 5B illustrating key points identified on a rump of the cow.

FIG. 6A is an exemplary depth image of a cow having passed through the cattle conformation evaluation system.

FIG. 6B is an exemplary mask image after morphological processing has been applied to the exemplary side-view depth image of FIG. 6A.

FIG. 6C is the mask image from FIG. 6B illustrating key points identified on a rear leg of the cow.

FIG. 7 is an exemplary point cloud image formed at least in part from the top-view depth image of FIG. 5A.

FIG. 8 is an exemplary two-dimensional image developed from the first point cloud image from FIG. 7 and taken along line VIII-VIII according to one example.

FIG. 9 is another exemplary two-dimensional image developed from the first point cloud image from FIG. 7 and taken along line VIII-VIII according to another example.

FIG. 10 is an exemplary two-dimensional image developed from the first point cloud image from FIG. 7 and taken along line X-X according to yet another example.

FIG. 11 is another exemplary point cloud image formed at least in part from the top-view depth image of FIG. 5A.

FIG. 12 is an exemplary two-dimensional image developed from the second point cloud image from FIG. 11 and taken along a wither slice line WL according to one example.

FIG. 13 is a top-view two-dimensional flattened image developed from the second point cloud image from FIG. 11.

FIG. 14 is a side-view and a rear-view perspective point cloud image of the cow illustrating a center point.

FIG. 15 is another exemplary two-dimensional image developed from the point cloud image of FIG. 14 and taken along an XZ plane cut through the center point.

FIG. 16 is an enlarged view of the exemplary mask image from FIG. 6C and including linear data.

FIG. 17 is another exemplary two-dimensional image extracted from the point cloud image of FIG. 14.

FIG. 18 is another exemplary two-dimensional image extracted from the point cloud image of FIG. 14.

FIG. 19 is another exemplary depth image of a rear of the cow having passed through the cattle conformation evaluation system.

FIG. 20 illustrates another exemplary point cloud image formed from at least the exemplary depth image of FIG. 19.

FIG. 21 is an enlarged pseudo-color image formed from at least the exemplary depth image of FIG. 19.

FIG. 22 is an exemplary two-dimensional image illustrating a transverse slice of the exemplary point cloud image from FIG. 21 and projected onto an XY plane.

FIG. 23 is another exemplary depth image of a side of the cow.

FIG. 24 is an exemplary mask image processed from the exemplary depth image from FIG. 23.

FIG. 25 is another exemplary depth image of a side of the cow showing two right hooves close together.

FIG. 26 is another exemplary depth image of a side of the cow showing two left hooves close together.

FIG. 27 is another exemplary depth image of a side of the cow.

FIG. 28 is another exemplary depth image of a side of the cow.

FIG. 29 is an enlarged image of the depth image from FIG. 28.

FIG. 30 illustrates a neural network that determines a current body condition score for the cow.

FIG. 31 is a flow chart showing a method of evaluating cattle conformation utilizing the cattle conformation evaluation system.

### DETAILED DESCRIPTION

Before any embodiments, examples, features, and aspects are explained in detail, it is to be understood that the disclosure is not limited in its application to the details of construction and the arrangement of components set forth in the following description or illustrated in the following drawings. The embodiments, examples, features, and aspects are capable of other implementations and of being practiced or of being carried out in various ways.

Also, it is to be understood that the phraseology and terminology used herein is for the purpose of description and should not be regarded as limiting. The terms “mounted,” “connected,” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using known means including wired connections, wireless connections, etc.

The disclosure herein generally relates to a cattle conformation evaluation system, referred to herein simply as the system. The system utilizes images captured by cameras to measure and/or calculate various traits associated with a cow passing by the cameras in real-time. The traits may include, but are not limited to, linear measurements (rump angle, rump width, stature, dairy form, foot angle, rear udder height, udder depth, rear udder width, teat length, udder tilt, udder cleft, teat distance, teat diameter, leg swing out, udder attachment angle, body depth, strength, wither angle), body condition scores (sacral ligament radius of curvature, spine radius of curvature, thurl radius of curvature, hook radius of curvature, pin radius of curvature), and mobility metrics (hoof distance, back arch, tracking up distance). In some examples, the body condition score (“BCS”) and mobility metrics are normalized to a 0-100 scale based on their minimum and maximum values within the herd.

The system may employ multiple, three-dimensional (3D), time-of-flight (TOF) cameras positioned in an exit alley from a milking parlor. The TOF cameras are configured to capture high-resolution, three-dimensional (3D) images, referred to herein as real-time images, of each cow passing through. Collected real-time images can be transmitted to a ruggedized on-farm computer. The real-time images are then processed, and measurements are extracted directly from the processed images. Some measurements equate directly to a trait associated with the cow, whereas some measurements contribute to a determination (e.g., a calculation) of a trait associated with the cow (e.g., the BCS). Artificial intelligence and deep learning techniques may be used to analyze the real-time images of each cow and may contribute to the determinations and/or the calculations of the traits.

The system is configured to automatically collect data on individual cows during their exit from the milking parlor. Cows may be identified using an ear tag reader (e.g., Radio Frequency Identification (RFID) reader) located proximate the exit alley. Images may be collected once daily or weekly or at another appropriate time depending on a milking schedule. The system is configured to mark, tag, or otherwise identify a cow that deviates from a baseline set of traits. The baseline set of traits may include a standard collection of values/images associated with known scores (e.g., a rump angle of between 170 and 180 correlates to a BCS of 4.5, a side-view image of a cow correlating with a BCS of 3). The baseline set of traits may also include standard deviations and their corresponding ranges for the various traits associated with a cow. The system may generate reports, by way of example in spreadsheet format, that can be delivered to a dairy manager, or other individuals interested in accessing this data, deposited into cloud storage, or imported into herd management software.

FIG. 1 illustrates a schematic of a cattle conformation evaluation system, referred to herein as system 100, according to one example. In the example shown, the system 100 includes a ruggedized on-farm computer 108, an RFID reader 110, a blocking screen 112, and a set of cameras 114. By way of example, the system 100 is provided at an exit alley 116 of a milking parlor (not shown). The exit alley 116 is defined at least in part by a barrier 118. While a barrier 118 may typically be made of steel pipe, for the system 100 described herein, it is beneficial to have the barrier 118 made of a material capable of containing the cow 120 while minimizing occlusion of the cow 120, by way of example steel cables. Cows 120 with ear tags 122 pass through the exit alley 116 when finished with the milking process where the set of cameras 114 are configured to collect real-time images of the cows 120.

The set of cameras 114 may include any number of cameras. A top-view camera 114t may be configured to capture the real-time images from above the cow 120. Additional cameras 114a may capture additional perspectives of the cow 120 (e.g., an udder-view, a rear-view, a left-side-view, a right-side-view, etc.). The top-view camera 114t is located at a height dimension (“Dt”) above a ground 126 of the exit alley 116. In one implementation of the system, the height dimension is nine feet (Dt=9′). It should be understood that the cow 120 needs to walk freely through the exit alley 116, so the rest of cameras 114 should be mounted at appropriate locations in order to prevent unnecessary interference with the cow 120. The set of cameras 114 are mounted such that the real-time images include a head, a body, an udder, a tail, and a rump of the cow.

The RFID reader 110 is mounted in a location appropriate for detecting the ear tag 122 to identify the correct cow 120 in the captured real-time images. In one example, the RFID reader is located at an exit 124 of the exit alley 116. In another example, the RFID reader 110 is positioned below the top-view camera 114t so as to read the ear tag 122 as the head moves directly below the top-view camera 114t. The RFID reader 110 and the set of cameras 114 are connected to the ruggedized on-farm computer 108 via wired or wireless, or a combination of the two, connection.

The exit alley 116 may include a gate movable between an open position and a closed position. While the set of cameras are capturing the real-time images, the gate may be in the closed position. In one example, upon completion of capturing the real-time images, a motor or other actuator is controlled so that the gate moves between the closed position and the open position. In one example, when the trait determined is within a predetermined amount of a set of baseline traits, a “green light” alert is generated, and the gate opens. It is further contemplated that when the trait determined deviates from the predetermined amount, a “red light” alert is generated, and the gate remains closed so that the cow 120 is retained for further evaluation. Regardless of the presence or absence of a physical gate the “green light” and “red light” alerts may be in the form of at least one of a physical light indicator, an audible alert, or a digital tag.

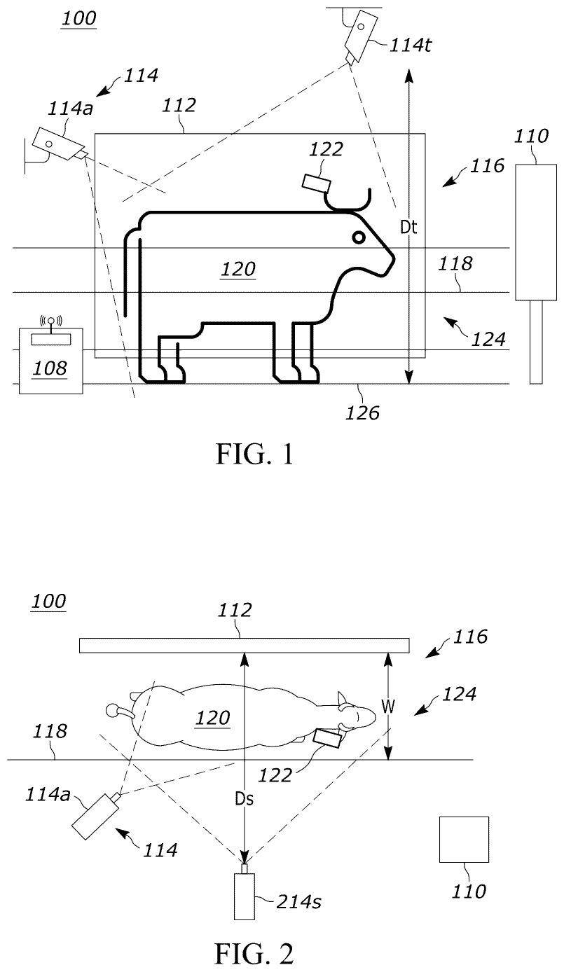

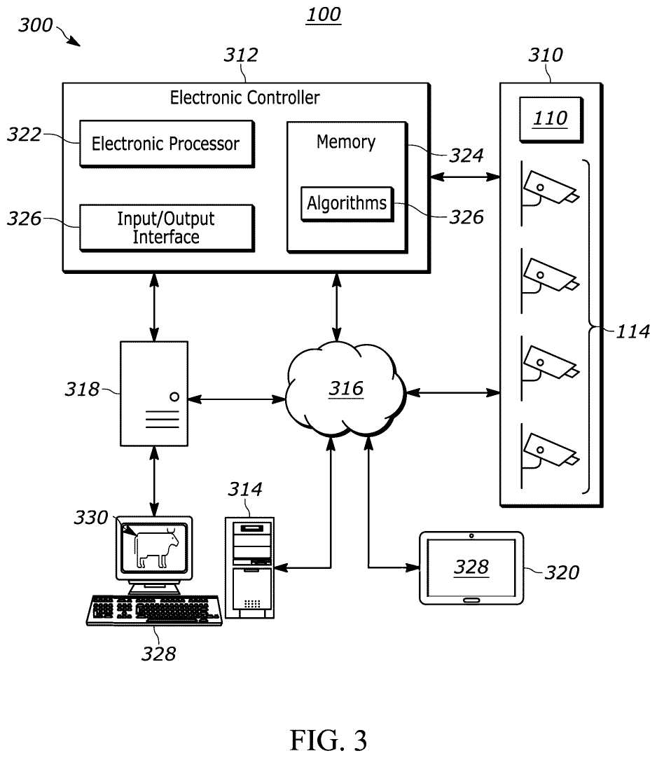

FIG. 2 is a top view of the system 100 from FIG. 1. The exit alley 116 has a width (“W”) extending from the barrier 118 to the blocking screen 112. The set of cameras 114 may include a side-view camera 214s mounted on one side of the exit alley 116 at depth dimension (“Ds”) from the blocking screen 112. In one implementation of the system, the depth dimension is nine feet (Ds=9′). The side-view camera 214s is configured to capture the real-time images including a right side (or left side depending on the orientation of the side-view camera 214s) of the cow. The blocking screen 112 blocks any background objects including other cows that may interfere with images captures by the side-view camera 214s. In one example the additional camera 114a is an udder camera situated close to the ground 126 and arranged to capture the udder of the cow 120.

The set of cameras 114 are TOF cameras according to one example. A 3D imaging TOF camera such as a Lucid Helios™ TOF camera with a Sony® TOF image sensor may be used. In some instances, the set of cameras 114 indirectly measure the time it takes for light to travel from the camera 114 to the cow 120 and back. A TOF camera emits pulses of light and measures the time it takes for the light to return to the sensor. This time measurement allows for a calculation of depth information. A TOF camera provides more detail and highly accurate imaging when compared to other types of cameras. While four cameras are illustrated, less cameras are contemplated. For example, a single moving camera may be utilized to capture all the views necessary. In certain instances, the top-view camera 114t looking straight down at the cows 120 as they walk directly under along the exit alley 116 provides a sufficient view of the cow 120 to enable data analysis. Using four cameras, however, provides additional views which enable a more comprehensive collection of data for analysis. The set of cameras 114 may be ruggedized to at least an IP65 standard.

FIG. 3 is a schematic of the system 100 for evaluating cattle conformation illustrating hardware components 300 according to one example. In the example shown, the hardware components 300 include on-site components 310 including the set of cameras 114 and the RFID reader 110. Additional hardware components 300 include an electronic controller 312 and a host computer 314, in one example the host computer 314 is the ruggedized on-farm computer 108 or in direct communication with the ruggedized on-farm computer 108. Hardware components 300 may also include a remote server 316, a local server 318, and a smart device 320, such as a tablet or smartphone.

The electronic controller 312 includes an electronic processor 322 (for example, a microprocessor, application specific integrated circuit, etc.), a memory 324, and an input/output interface 326.

The electronic processor 322 is coupled to the memory 324 and the input/output interface 326. The electronic processor 322 sends and receives information (for example, from the memory 324 and/or the input/output interface 326) and processes the information by executing one or more software instructions or modules, capable of being stored in the memory, or another non-transitory computer readable medium. The software can include firmware, one or more applications, program data, filters, rules, one or more program modules, and other executable instructions. The electronic processor 322 is configured to retrieve from the memory 324 and execute, among other things, software for performing methods as described herein.

The memory 324 may be made up of one or more non-transitory computer-readable media and includes at least a program storage area and a data storage area. The program storage area and the data storage area can include combinations of different types of memory, such as read-only memory (“ROM”), random access memory (“RAM”), electrically erasable programmable read-only memory (“EEPROM”), flash memory, or other suitable memory devices.

The input/output interface 326 transmits and receives information from devices external to the electronic controller (for example, the other hardware components 300 via a wired or wireless connection). The hardware components 300 may be connected to each other using, for example, ethernet cables that provide power over ethernet. It should be understood that additional hardware components 300 than those illustrated in FIG. 3 and in various configurations are also contemplated. For example, in some examples, the hardware components 300 includes multiple electronic controllers, multiple electronic processors, multiple memories, multiple input/output interfaces, or a combination thereof. The RFID reader 110 may include a dedicated processing unit for reading the ear tags 122 and transmitting the identification data to the host computer 314 via the input/output interface 326.

The hardware components 300 may include or be connected a user interface. To avoid illustrating multiple user interfaces, a single user interface 328 is illustrated. It should be understood that while it is possible that the hardware components share the same user interface 328. It is also possible that each hardware component includes a separate user interface. The user interface 328 is configured to receive input from a user. The user interface 328 provides visual output, such as, for example, graphical indicators (for example, fixed or animated icons), lights, colors, text, images, combinations of the foregoing, and the like. The user interface 328 includes a suitable display mechanism for displaying the visual output, such as, for example, a liquid crystal display (LCD) touch screen, or an organic light-emitting diode (OLED) touch screen), or other suitable mechanisms. In some instances, the user interface displays a graphical user interface (GUI) (for example, generated by the electronic controller and presented on a display screen) that enables a user to interact with the system. The user interface 328 may also provide audio output to the driver via a chime, buzzer, speaker, or other suitable device, by way of example a smart phone/tablet including the user interface 328. In one example, marking, tagging, or otherwise identifying a cow that deviates from the baseline set of traits the system includes generating a graphical user interface element 330 for display on the user interface 328. For example, a generic illustration of a cow with graphical elements representing a deviation of the trait from a corresponding one of the baseline set of traits by a predetermined amount.

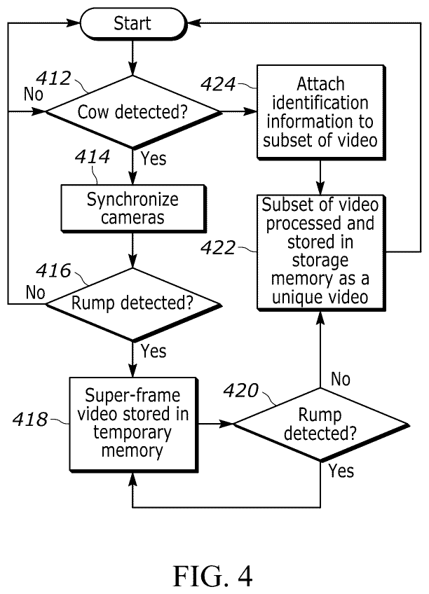

FIG. 4 is a flowchart of an example algorithm 400 implemented by the electronic processor 322 via software stored, by way of example, in the memory 324. The algorithm 400 is designed to process images from two or more cameras in the set of cameras 114. The camera type limits a number of frames per second captured by the system 100. Each camera in the set of cameras 114 should capture at least 10 frames per second. In other examples each camera captures 30 frames per second.

The set of cameras 114 are turned on at block 410, by way of example, during a milking process. The milking process may occur twice or three times a day. During the milking process the set of cameras 114 run continuously. At block 412, a cow 120 is detected by any of the set of cameras 114 or registered by the RFID reader 110. At block 414, upon detecting the presence of the cow 120, all cameras 114 in the set of cameras 114 are synchronized.

At block 416 the rump is detected. The set of cameras 114 utilizes a pattern detection process running in the electronic processor 322, for example a Cascade Classifier, trained to detect the rump of the cow 120 from a top view. Upon detecting the rump, at block 418, all of the synchronized frames of video from each camera are concatenated together into a super-frame video with the super-frame video stored in a temporary memory space, by way of example located in the memory 324, in the remote server 316, or in the local server 318. At block 420 this process continues until the rump is no longer detected. At block 422, recording of super frames to the temporary memory space is halted upon no longer detecting the rump. A subset of video is selected from the temporarily stored super-frame videos. The subset of video is processed as a unique video and stored in storage memory, by way of example located in the memory 324, in the remote server 316, or in the local server 318.

At block 424 identification data from the ear tag 122 and associated with each cow 120 is attached to the unique video (i.e., the video of one identified cow). For example, the host computer 314 receives the identification data and keeps a recording of the most recently received identification data. With each new super-frame video, the most recently received identification data is appended to meta data associated with each super-frame video. This same meta data is attached to the unique video and stored in the storage memory.

In certain instances, the unique video is a constant rate video showing the cow 120 moving equal increments through a field of view. In this way, regardless of the speed or loitering of the cow 120, the unique video associated with each cow 120 appears to show the cow 120 moving across the field of view at a constant rate without stopping and without speeding up. This ensures that the unique video files are reasonably small in size.

In one example, the set of cameras 114 runs during a full milking session, at the end of the milking session the electronic processor 322 causes the system 100 to switch from recording and storing the super-frame videos at block 418 to processing the unique videos at block 422. By way of example the storage memory is located in the remote server 316 where the unique videos may be categorized by farm and date (e.g., by the file name to which the farm name and date stamp were added when the file was created). Each unique video includes the identification data for each cow received from the RFID reader 110. ERS

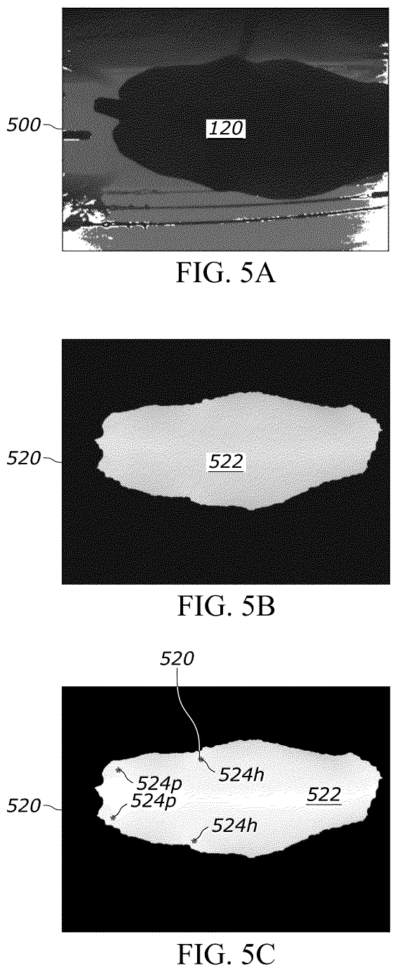

FIGS. 5A-25 illustrate various images obtained and/or processed from the unique video captured by the set of cameras 114. The images may be processed, by way of example, using the electronic processor 322 located in the host computer 314. Processing the images enables extraction of various traits associated with the individual cow 120. The various traits may be calculated or directly determined from the images/processed images.

In one example, during the imaging process, in an event insufficient imaging has occurred, the “red light” alert is generated and the cow 120 is held for re-imaging. It is further contemplated that when the imaging process is successful the “green light” alert is generated and the cow 120 continues through the exit 124.

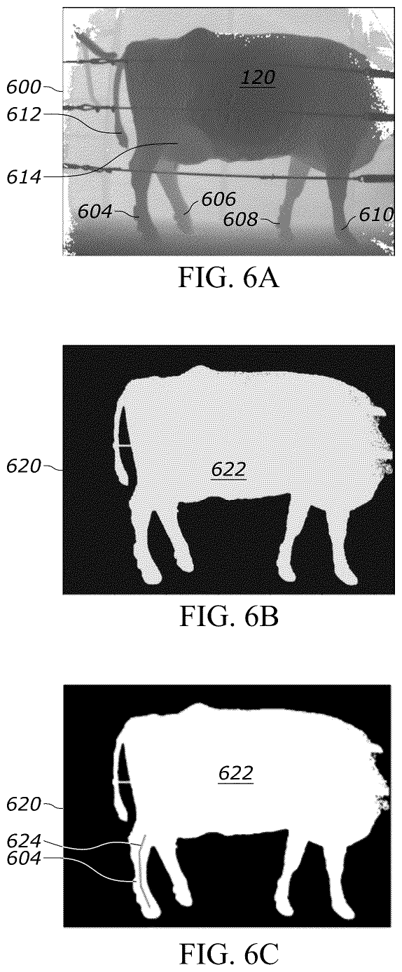

Turning to FIGS. 5A-5C processing images of the unique video obtained from the top-view camera 114t is illustrated. FIGS. 6A-6C illustrates processing images of the unique video obtained from the side-view camera 214s. While illustrated with reference to images obtained from the top-view camera 114t and the side-view camera 214s, it should be understood that similar processing may be done with images obtained from any one or multiple of the set of cameras 114.

FIG. 5A illustrates a first depth image 500 after subtraction of background frames from multiple images of the unique video.

FIG. 5B illustrates a first mask image 520 with a masked region 522 of the cow 120 after morphological processing has been applied to the first depth image 500.

FIG. 5C illustrates the first mask image 520 from FIG. 5B with key points 524 from the rump of the cow 120 roughly located in the masked region 522. The key points 524 include pin points 524p and hook points 524h.

FIG. 6A illustrates a second depth image 600 after subtraction of background frames from multiple images of the unique video. The second depth image 600 is a side-view image showing a right rear leg 604, a left rear leg 606, a left front leg 608, and a right front leg 610. The side-view image also shows a tail 612 and an udder 614 of the cow 120.

FIG. 6B illustrates a second mask image 620 with a masked region 622 of the cow 120 after morphological processing has been applied to the second depth image 600.

FIG. 6C illustrates the second mask image 620 from FIG. 6B with key points 524 including linear data 624 from the right rear leg 604 of the cow 120 roughly located in the masked region 622.

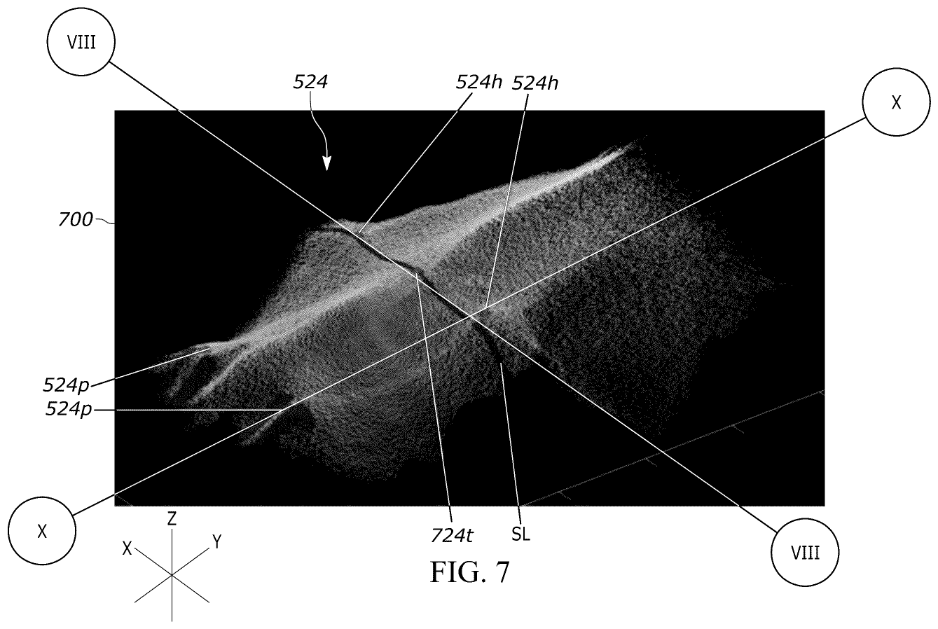

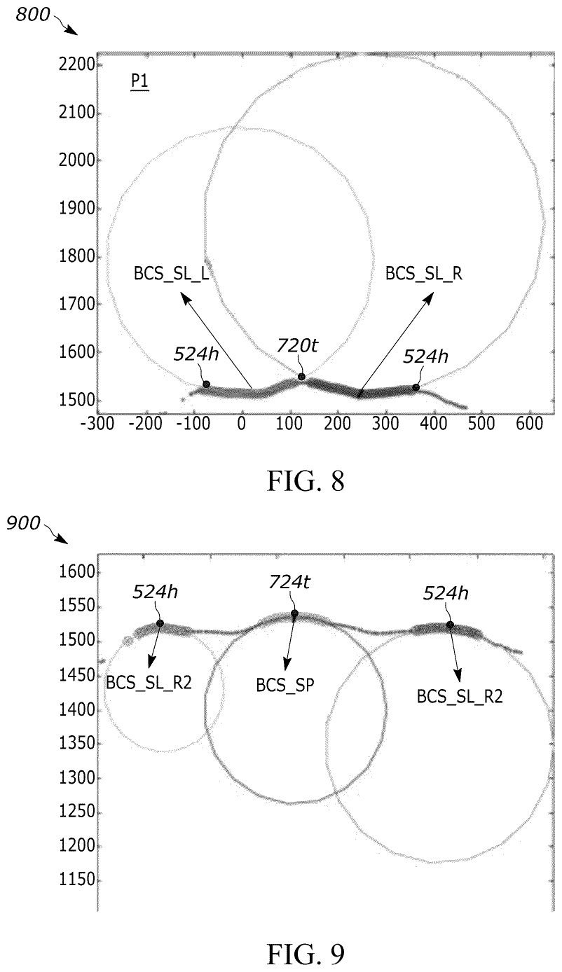

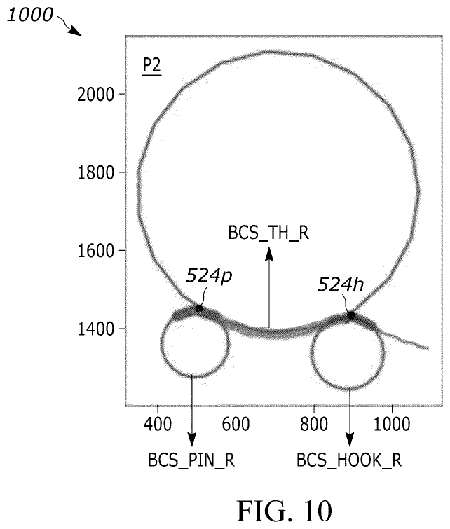

FIG. 7 illustrates a first point cloud image 700 formed from at least the first depth image 500 of FIG. 5A. The first point cloud image 700 includes the key points 524. The first point cloud image 700 is a three-dimensional (3D) rendering of the rump of the cow 120 oriented along three axes. A first horizontal axis (“X”) extends generally through a width of the cow 120 and a second horizontal axis (“Y”) is perpendicular to the X axis and parallel to the cows' tail to head direction. A vertical axis (“Z”) is oriented perpendicular to the ground 126 (FIG. 1). Using the key points 524, a first plane (“P1” FIG. 8 and FIG. 9) extending in an XZ plane located along line VIII-VIII and a second plane (“P2” FIG. 10) extending in a YZ plane located along line X-X, are determined.

A line of best fit between the hook points 524h defines a sacral ligament slice line (“SL”). The point at which the line of best fit peaks between the hook points 524h defines a key point 524 as a spine point 724t. The spine point 724t is aligned with a spine of the cow 120.

While illustrated with reference to real-time images obtained from the top-view camera 114t, it should be understood that the first point cloud image 700 can be a point cloud image of any part of the cow 120 obtained from real-time images from any one or multiple of the set of cameras 114.

FIG. 8 is a first two-dimensional (2D) image 800 developed from the first point cloud image 700 and providing a view of the hook points 524h and the spine point 724t in the first plane P1 located along line VIII-VIII of FIG. 7. The sacral ligament SL extends between one hook point 524h and the spine point 724t to define a radius of curvature. A left radius of curvature (“BCS_SL_L”) for the sacral ligament represents a first trait for the cow 120. A right radius of curvature (“BCS_SL_R”) for the sacral ligament is a second trait for the cow 120.

FIG. 9 is second 2D image 900 developed from the first point cloud image 700 and providing a view of the hook points 524h and the spine point 724t in the first plane P1 located along line VIII-VIII of FIG. 7. The sacral ligament SL extends between two troughs and peaks at the hook points 524h and the spine point 724t to define other radii of curvature. A spine radius of curvature (“BCS_SP”) along the sacral ligament is a third trait for the cow 120. A second left radius of curvature (“BCS_SL_L2”) for the sacral ligament is a fourth trait for the cow 120. A second right radius of curvature (“BCS_SL_R2”) for the sacral ligament is a fifth trait for the cow 120.

FIG. 10 is a third 2D image 1000 developed from the first point cloud image 700 and providing a view of one of the hook points 524h and one of the pin points 524p in the second plane P2 located along line X-X of FIG. 7. The curvature extending between corresponding hook and pin points 524h, 524p is called a thurl (“TH”). The thurl TH on the right side defines a right side thurl radius of curvature (“BCS_TH_R”) in the second plane P2 located along line X-X of FIG. 7. While not illustrated, it should be understood that the thurl TH on the left side defines a left side thurl radius of curvature (“BCS_TH_L”). Both the right and left side thurl radii of curvatures are sixth and seventh traits for the cow 120.

The hook point 524h on the right side defines a right side hook radius of curvature (“BCS_HOOK_R”) in the second plane P2. The pin point 524p on the right side defines a right side pin radius of curvature (“BCS_PIN_R”) in the second plane P2. While not illustrated, it should be understood that the hook point 524h and the pin point 524p on the left side define left side hook and left side pin radii of curvature (“BCS_HOOK_L”, “BCS_PIN_L”). Both the left side hook and left side pin radii of curvatures are eight, ninth, tenth, and eleventh traits for the cow 120.

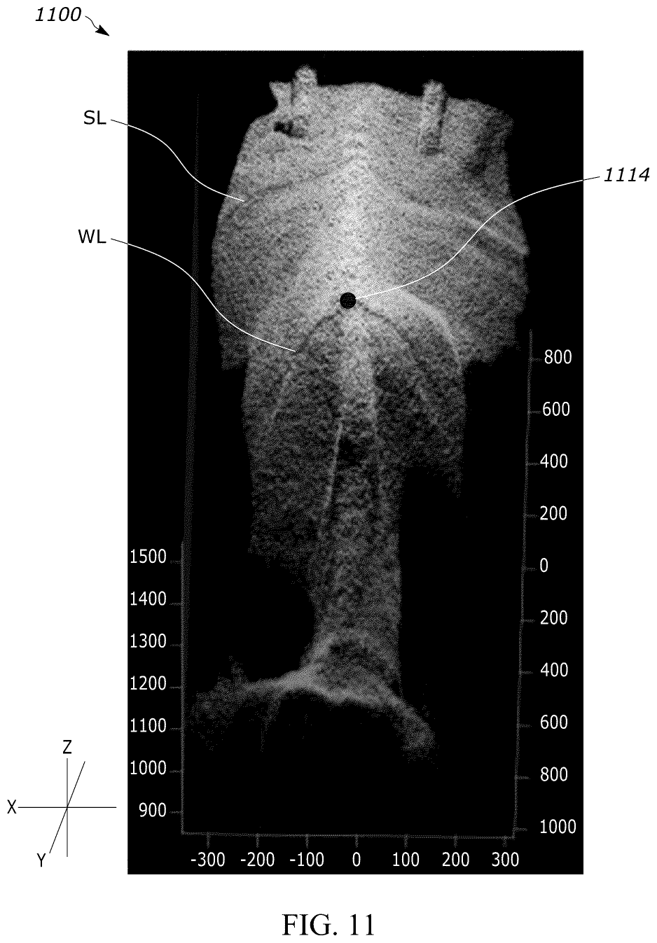

FIG. 11 illustrates a second point cloud image 1100 from a top-view perspective illustrated in 3D. The second point cloud image 1100 is formed as described herein, with gathered real-time images in part from at least the top-view camera 114t. A wither slice line (“WL”) is a line taken a predetermined distance (“D”) (e.g., 50 cm) away from the sacral ligament slice line SL measured along the Y-direction toward the cow's head. The wither slice line WL is perpendicular to the Y-axis. A highest point 1114 is the highest point in the Z-direction along the whither slice line WL.

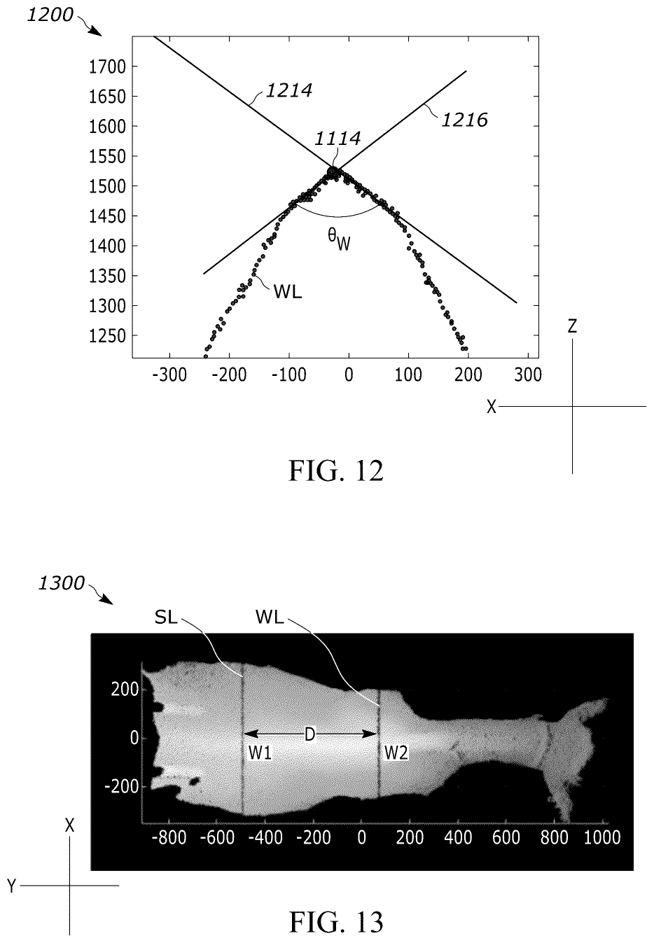

FIG. 12 illustrates a fourth 2D image 1200 developed from the second point cloud image 1100 and providing a projection of the wither slice line WL onto an XZ plane. Select points within 100 mm in the X-direction from the highest point 1114 are fit into two straight lines, 1214 and 1216, respectively. A wither angle (“θ_{w}”) between the two lines indicates another trait for the cow 120. The wither angle θ_{w} defines a first dairy form DF1. The first dairy form DF1 is a twelfth trait for the cow 120.

DF1=θ_{w} (Equation 1)

Turning to FIG. 13, the second point cloud image 1100 is flattened into a fifth 2D image 1300 along an XY plane to measure a first width (“W1”) along the sacral ligament slice line SL. A second width (“W2”) is measured along the wither slice line WL. A second dairy form DF2 is calculated using the first width W1 and the second width W2. The second dairy form DF2 is also referred to as a spring of rib. The second dairy form DF2 is a thirteenth trait for the cow 120.

$$DF 2 = \frac{W 1 - W 2}{W 1} \qquad ( Equation 2 )$$

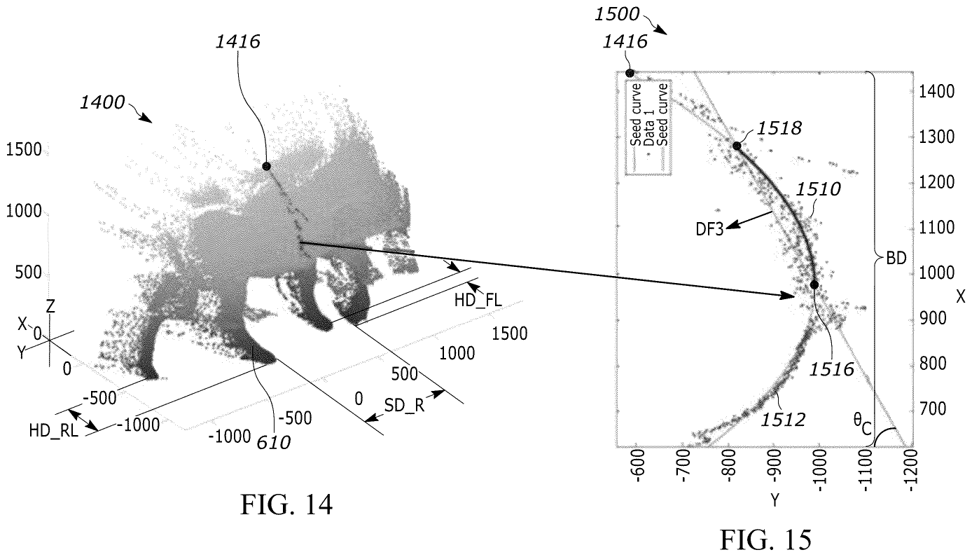

FIG. 14 is a third point cloud image 1400 from a side-view and a rear-view perspective and illustrated in 3D. Hoof distances can be determined when both rear/front hooves on each side are in contact with the ground 126.

A first hoof distance (generally referred to herein as “HD”) is a width distance between the rear hooves. Two separate width distances may be measured, for example when a left rear hoof is behind and a right rear hoof is in front a rear left width distance (“HD_RL”) is measured between the two rear hooves. When the right rear hoof is behind and the left rear hoof is in front a rear right width distance (“HD_RR”) is measured between the two rear hooves. The rear left and right width distances are a fourteenth and a fifteenth trait for the cow 120.

Similarly, a second hoof distance is a width distance between the front hooves. Two separate width distances may be measured, for example when a left front hoof is behind and a right front hoof is in front a front left width distance (“HD_FL”) is measured between the two front hooves. When the right front hoof is behind and the left front hoof is in front a front right width distance (“HD_FR”) is measured between the two front hooves. The front left and right width distances are a sixteenth and seventeenth trait for the cow 120.

A third hoof distance is a stride distance (generally referred to herein as tracking up “TU”) between the side hooves. Two separate stride distances may be measured, for example when the left rear hoof is close to a left front hoof a left side stride distance (“TU_L”) is measured between the two left hooves. When the right rear hoof is close to a right front hoof a right side stride distance (“TU_R”) is measured between the two right hooves. The left and right stride distances are an eighteenth and a nineteenth trait for the cow 120. When the right (or left) hooves are closest together, or the TU_R (or TU_L) is measured at a minimum value, a center point 1416 of the TU_R (or TU_L) along the X-axis is determined.

FIG. 15 is a sixth 2D image 1500 developed from the third point cloud image 1400 and taken along an XZ plane cut through the center point 1416 with points 1510 extracted from the third point cloud image 1400. The points 1510 define a curve 1512. Cutting the third point cloud image 1400 along the XZ plane at the center point 1416 provides additional parameters for determining more Traits. A body depth (“BD”) is measured in the Z-direction between the highest and lowest points 1510 in the XZ plane. The body depth BD is a twentieth trait for the cow 120.

A third dairy form DF3 is determined by taking a key point 524 at an outermost point 1516 of the curve 1512, moving upwards along the Z-axis by a predetermined distance, e.g., 300 mm, to find another key point 524 of a point 1518. An angle of curvature (“θ_{c}”) between the line formed by point 1516 and point 1518 and the X-axis defines the third dairy form DF3.

DF3=θ_{c}

It should be understood that a third dairy form DF3 can be determined for both the left and right sides of the cow 120. Therefore, the third dairy form DF3 for the left and right sides of the cow are a twenty-first and twenty-second trait for the cow 120.

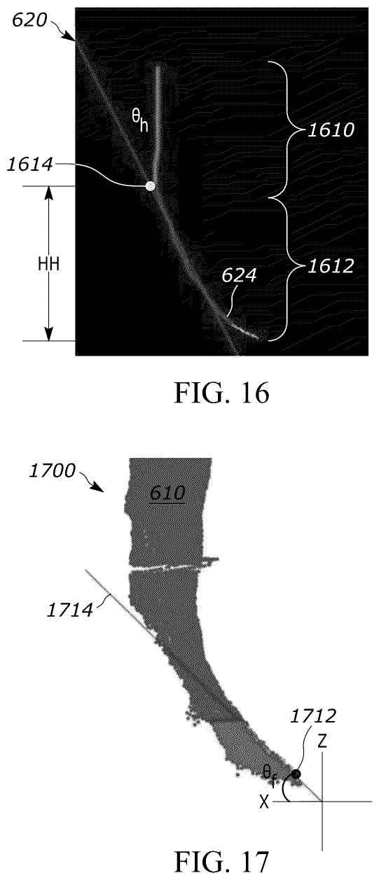

FIG. 16 is an enlarged view of the mask image 620 and including the linear data 624. Using vertical analysis, the right rear leg 604 is divided into an upper section 1610 and a lower section 1612. The upper section 1610 and the lower section 1612 intersect at key point 524, a hock 1614, of the right rear leg 604. A distance between the ground 126 and the hock 1614 along the vertical Z-axis defines a hock height (“HH”). The hock height may be determined using the left rear leg 606 as well. Therefore, the hock height HH is a twenty-third and twenty-fourth trait for the cow 120.

Two lines are fit, one to the upper section 1610 and one to the lower section 1612. A hock angle (“θₕ”) between the two lines indicates an additional trait for the cow 120. The hock angle θₕ for both rear legs 604, 606 is a twenty-fifth and twenty-sixth trait for the cow 120.

FIG. 17 illustrates a seventh 2D image 1700 extracted from the third point cloud image 1400. The seventh 2D image 1700 is a 2D portion of a 3D rendering of the rear right leg of the cow 120 taken along the XZ plane. A key point 524 is defined at a furthest right point 1712 and is fit to a line 1714 where a foot angle (“θ_{f}”) between the line 1714 and the X-axis for each leg represents a twenty-seventh and twenty-eighth trait for the cow 120.

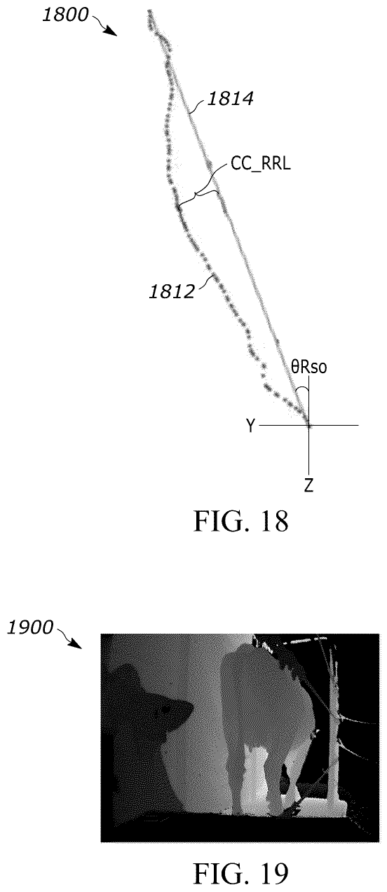

Turning to FIG. 18, an eighth 2D image 1800, including points 1812 extracted from the third point cloud image 1400, is illustrated. The points 1812 are projected onto a YZ plane. A swing out (generally referred to herein as “SO”) line 1814 extends from the uppermost point to the lowermost point of the points 1812 relative to the Z-axis. A swing out angle for the right rear leg (“θRₛₒ”) is defined between the swing out line 1814 and the Z-axis. A maximum distance between the swing out line 1814 and the points 1812 represents a maximum curve concavity for the right rear leg (“SO_CC_RRL”). While not illustrated, it should be understood that determining a swing out angle for the left rear leg (“θLₛₒ”) and a maximum curve concavity for the left rear leg (“SO_CC_LRL”) is also contemplated. The swing out angle and maximum curve concavity account for a twenty-ninth, a thirtieth, a thirty-first, and a thirty-second trait of the cow 120.

FIG. 19 is a third depth image 1900 after subtraction of background frames from multiple images of the unique video as described herein. The third depth image 1900 may be generated from images obtained from at least the rear-view camera 114r.

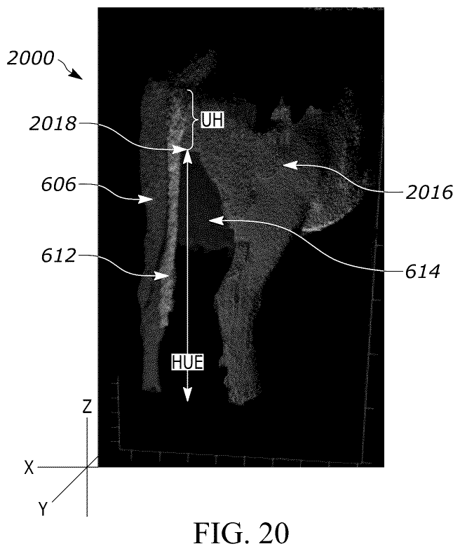

FIG. 20 illustrates a fourth point cloud image 2000 formed from at least the third depth image 1900 of FIG. 19. The fourth point cloud image 2000 includes the udder 614 of the cow 120. At a maximum value of the rear left width distance (“HD_RL”) (or the rear right width distance HD_RR) the fourth point cloud image 2000 is processed.

The fourth point cloud image 2000 is oriented such that an XY plane coincides with the ground 126 where the positive Y direction matches the cow's direction of movement. In one example a point cloud segmentation model (e.g., PointNet++) is trained to precisely segment the fourth point cloud image 2000 into four categories, the udder 614, the tail 612, the left (or right) rear leg 606, and other regions of the cow 2016.

A highest point 2018 of the udder 614 is recorded as a height of the udder edge (HUE). A rear udder height (UH) is calculated using the following equation:

$$UH = \frac{PinL + PinR}{2} - HUE \qquad ( Equation 4 )$$

PinL and PinR are the Z-coordinates for the pin points 524p.

The height of the udder edge HUE and the rear udder height UG are thirty-third and thirty-fourth traits of the cow 120.

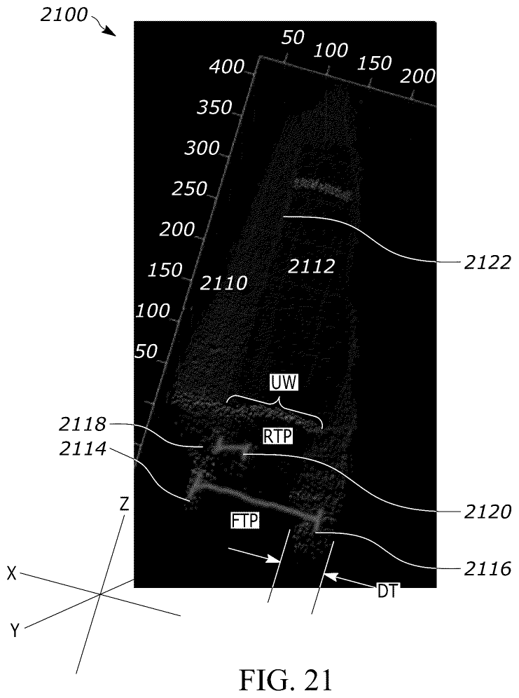

FIG. 21 is an enlarged pseudo-color image 2100 generated from the fourth point cloud image 2000 showing the udder 614. In one example a model (e.g., a YOLOv8 model) is trained to recognize a left udder 2110, a right udder 2112, a left front teat 2114, a right front teat 2116, a left rear teat 2118, and a right rear teat 2120.

If both the left front teat 2114 and the right front teat 2116 are detected, a distance between the two teats is recorded as a Front Teat Placement (“FTP”). The front teat placement FTP is a thirty-fifth trait of the cow 120.

If both the left rear teat 2118 and the right rear teat 2120 are detected, a distance between the two teats is recorded as a Rear Teat Placement (“RTP”). The rear teat placement RTP is a thirty-sixth trait of the cow 120.

A diameter of the teat (“DT”) can be measured for any of the teats detected. As there are four teats, the diameter of the teat DT can account for the thirty-seventh, thirty-eighth, thirty-ninth, and fortieth trait for the cow 120.

If both the left udder 2110 and the right udder 2112 are detected, an udder boundary line 2122 between the two udders is determined. A maximum horizontal distance between the udder boundary line 2122 and the udder's right (or left) side defines an udder width (“UW”). The udder width UW can account for a forty-first and forty-second trait of the cow 120.

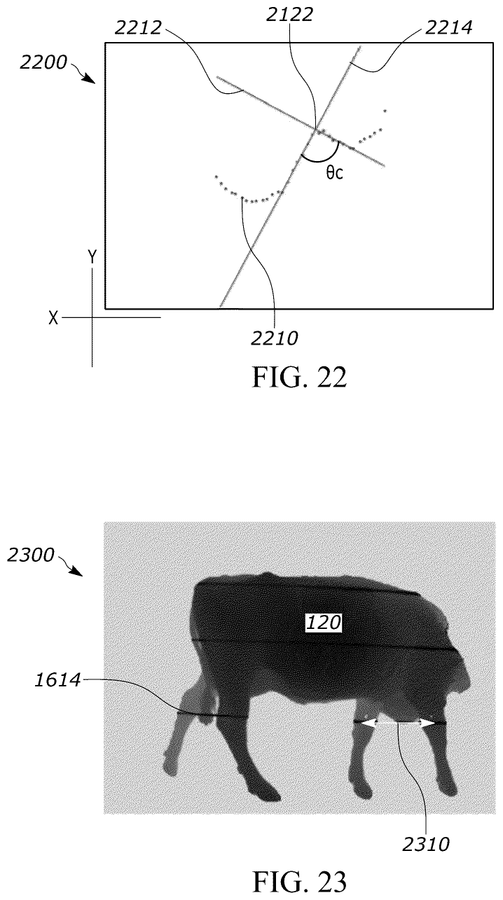

Turning to FIG. 22, a two-dimensional image illustrating a transverse slice 2200 of the fourth point cloud image 2000 extracted and projected onto an XY plane using a lower end of the udder boundary line 2122 as a reference is illustrated. An udder curve 2210 meets at the udder boundary line 2122. Two best fit lines 2212, 2214 for points on both sides of the udder boundary line 2122 along the udder curve 2210 together define a cleft angle (“θ_{c}”). The cleft angle θ_{c} accounts for a forty-third trait of the cow 120.

FIG. 23 illustrates an exemplary fourth depth image 2300 of a side of the cow 120. This fourth depth image 2300 clearly shows all four legs 604, 606, 608, 610. This image 2300 may be used to determine a strength trait for the cow 120. Upon locating the hock 1614, a corresponding point on the front legs 608, 610 is also determined. A distance 2310 between these two points on both the front and rear legs 604, 606 is a strength indicator for the cow 120, and accounts for a forty-fourth trait.

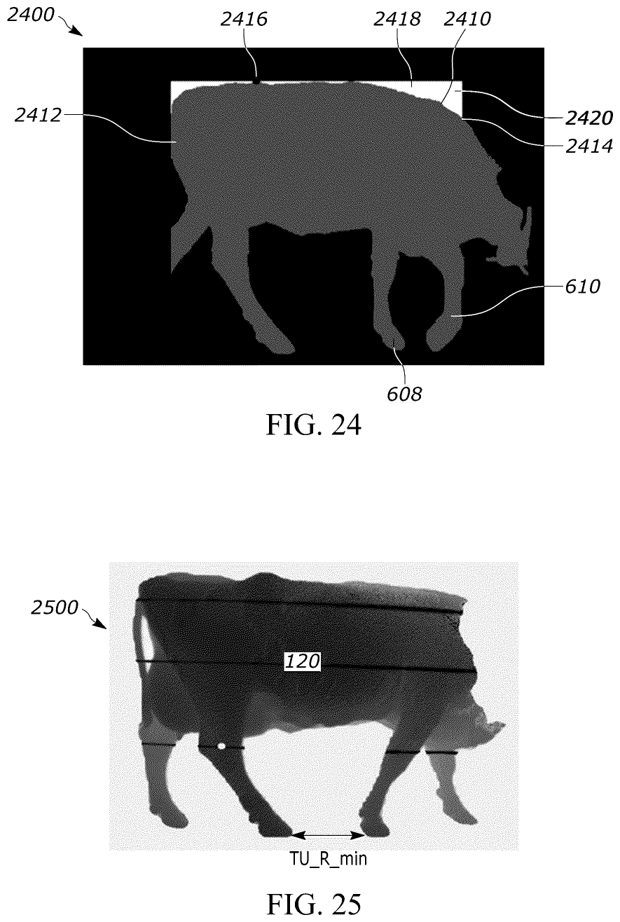

FIG. 24 illustrates a third mask image 2400 processed from a side-view depth image, such as the fourth depth image 2300. A back arch (“BA”) of the cow 120 can be determined from the third mask image 2400 A back contour 2410 is extracted from a root 2412 of the tail 612 to a point 2414 directly above the front legs 608, 610. Based on a highest point 2416 of the back contour 2410, a line 2418 is drawn and an area 2420 formed with the back contour 2410 can be calculated. The area divided by a length of the line 2418 defines the back arch BA. A first back arch degree (“BA_1”) can be calculated when all four legs are on the ground and HD_RL reaches its maximum value as shown in the fourth depth image 2300.

FIG. 25 illustrates an exemplary fifth depth image 2500 of a side of the cow 120. A minimum distance TU_R_min is the closest distance between the two right hooves over the entire unique video.

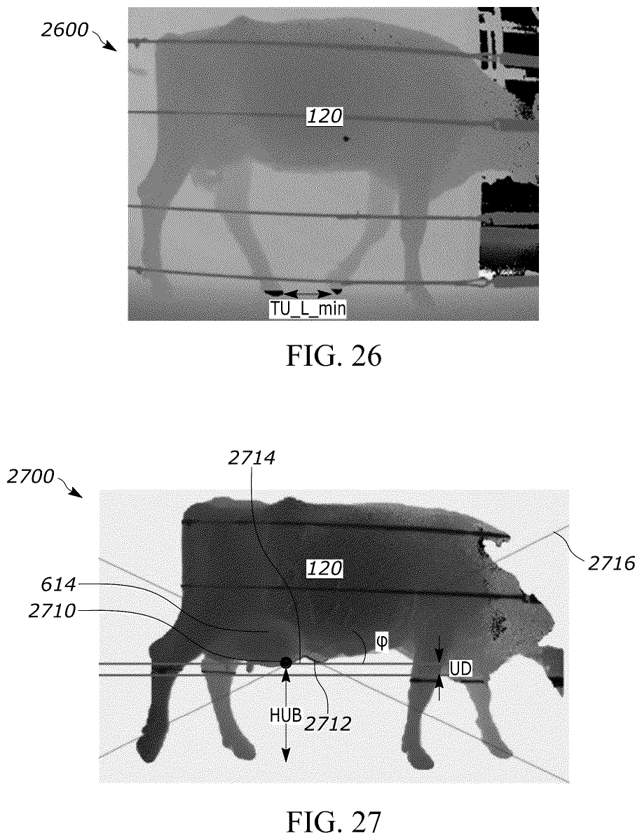

FIG. 26 illustrates an exemplary sixth depth image 2600 of a side of the cow 120. A minimum distance TU_L_min is the closest distance between the two left hooves over the entire unique video.

FIG. 27 illustrates an exemplary seventh depth image 2700 of a side of the cow 120. A distance from the ground 126 to a key point 524 being a lowest point 2710 of the udder 614 is recorded as the height of the udder bottom (“HUB”). Similarly, when all four legs are on the ground and HD_RR reaches its maximum value, a second back arch degree (“BA_2”) can be determined (FIG. 24). The first and second back arch degrees BA_1 and BA_2 account for a forty-fifth and a forty-sixth trait of the cow 120.

An udder depth (“UD”) is calculated using the following equation:

UD=HUB−HH (Equation 5)

Where HH is the hock height (FIG. 16). The udder depth UD and the height of the udder bottom HUB account for a forty-seventh and a forty-eighth trait of the cow 120.

Using the seventh depth image 2700, an udder bottom contour 2712 can be determined. Using protrusion analysis concave points 2714 along the udder bottom contour 2712 are determined. A fore udder attachment (“FU”) is determined as an angle (“φ”) between a line 2716 fit to the concave points 2714 and the horizontal axis along the Y-direction. The fore udder attachment FU accounts for a forty-ninth trait of the cow 120.

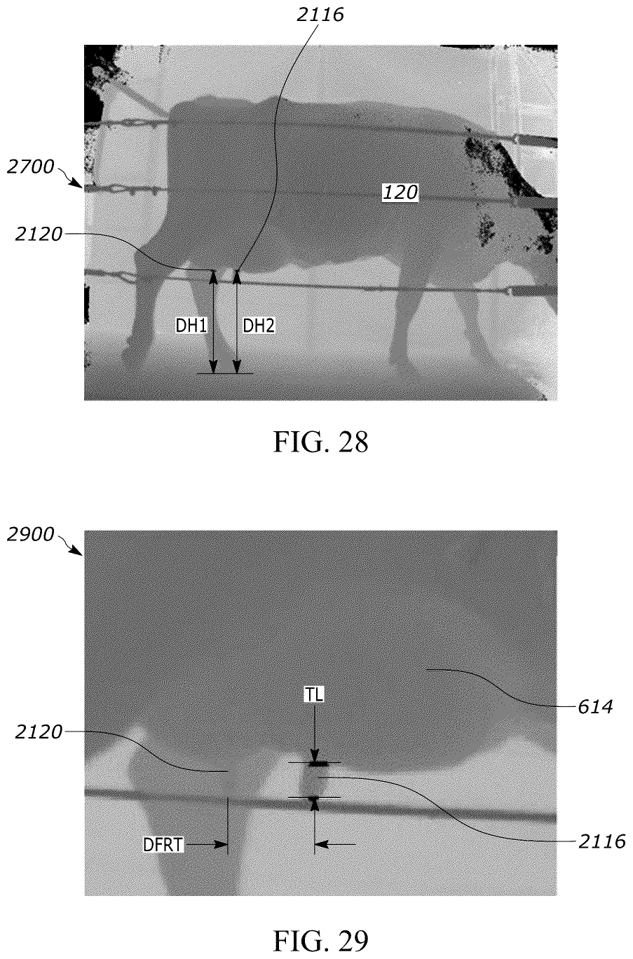

FIG. 28 illustrates seventh depth image 2700 to show a rear teat height (“DH1”) and a front teat height (“DH2”). Each height is determined as a distance from where the right (or left) rear front or rear teat 2116, 2120 extends from the udder to the ground 126 when all four hooves are in contact with the ground 126.

An udder tilt (“UT”) is calculated using the following equation:

UT=DH1−DH2 (Equation 6)

The udder tilt UT accounts for a fiftieth trail of the cow 120.

FIG. 29 is an enlarged image 2900 of the seventh depth image 2700 from FIG. 27. This enlarged image 2900 can be used to determine additional Traits for the cow 120. A distance between the right (or left) front teat 2116 and the right (or left) rear teat 2120 is recorded as the distance between front and rear teat (“DFRT”). Further, a teat length (“TL”) can be determined. While illustrated as the front teat length TL, it should be understood that a teat length TL for each teat can be determined from the enlarged image 2900. The distance between front and rear teat DFRT accounts for a fifty-first and fifty-second trait of the cow 120. The teat length TL can account for a fifty-third, fifty-fourth, fifty-fifth, and fifty-sixth trait of the cow 120.

The height of the udder bottom HUB, the fore udder attachment FU, the teat length TL, the udder tilt UT, the distance between the front and rear teat DFRT, the diameter of the teat DT and the swing out angle of the right and left legs Oso are determined when three or four limbs are in contact with the ground 126. All four limbs are on the ground 126 when either the rear left width distance HD_RL or the rear right width distance HD_RR are at a maximum value.

Using the extracted and calculated traits outlined above, an additional three traits can be determined:

### Asymmetry of Back Arc (“ABA”):

$$ABA = \frac{2 \times ( BA {1}_{avg} - BA {2}_{avg} )}{BA {1}_{avg} + BA {2}_{avg}} \qquad ( Equation 7 )$$

BA1_avg is the average value of the first back arch degree over the entire unique video and BA2_avg is the average value of the second back arch degree over the entire unique video.

### Asymmetry of Distance of Rear Hooves (“ADRH”):

$$ADRH = \frac{2 \times ( HD\_RL \_max - HD\_RR \_max )}{HD\_RL \_max + HD\_RR \_max} \qquad ( Equation 8 )$$

HD_RL_max is the maximum value of the rear left width distance over the entire unique video and HD_RR_max is the maximum value of the rear right width distance over the entire unique video.

### Asymmetry of Tracking Up (“ATU”):

$$ATU = \frac{2 \times ( TU\_L \_min - TU\_R \_min )}{TU\_L \_TU \_L \_min + TU\_R \_min} \qquad ( Equation 9 )$$

TU_L_min is the closest distance between the two left hooves over the entire unique video and TU_R_min is the closest distance between the two right hooves over the entire unique video.

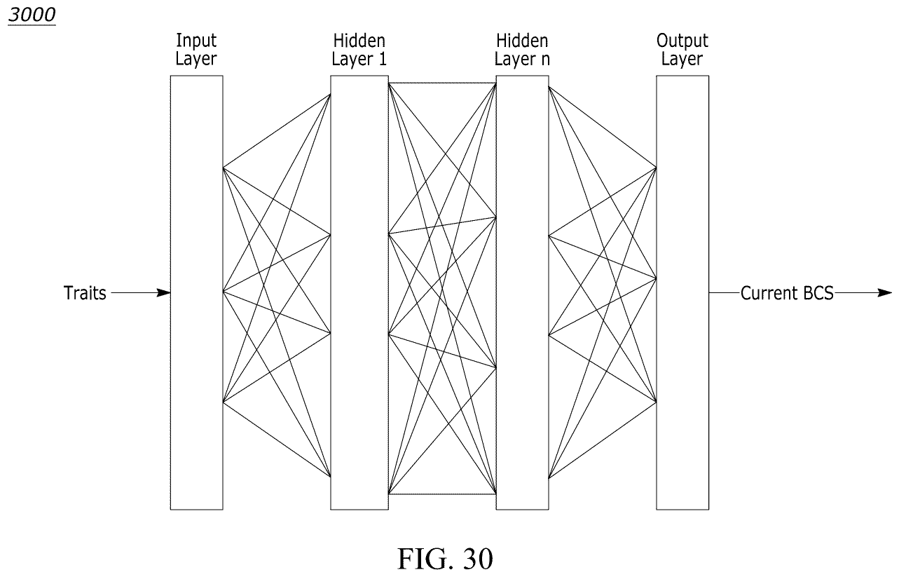

FIG. 30 illustrates a neural network 3000 that determines a current body condition score (“BCS”) for the cow 120. In one example over twenty traits are determined by the system 100. It is further contemplated that between twenty and sixty traits are determined. In some examples, the traits are input into the neural network 3000 to predict the current body condition score. In some instances, the neural network 3000 is a back propagation neural network trained to accurately determine the current BCS by being fed training data. In some instances, the training data includes existing images and corresponding predetermined body condition scores developed from subjective and known practices. The corresponding predetermined body condition scores may be subjectively determined (e.g., by an expert in the field). The training data is provided to the neural network 3000 where anatomical features of the livestock are associated with corresponding body condition scores. In one example, the “green light” alert and/or the “red light” alert described herein includes generating a digital tag. The digital tag may be connected to data output by the system 100. The data tag may be added to the training data provided to the neural network.

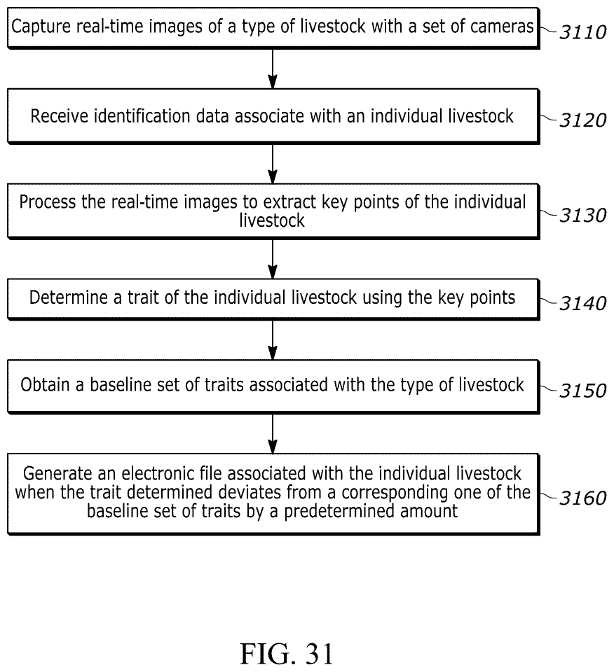

Turning to FIG. 31, a flow chart for a method 3100 of evaluating cattle conformation utilizing the system described herein with the processor 322 by implementing the algorithm 400 is illustrated. The method 3100 includes at block 3110 capturing real-time images of livestock (e.g., the cow 120) with the set of cameras 114.

At block 3120 the method 3100 includes receiving identification data, e.g., from the RFID reader 110, associated with the individual livestock at the electronic processor 322. The identification data may be a number identifying the individual livestock.

At block 3130 the method 3100 includes processing the real-time images to extract the key points (e.g., any of the key points 524 described herein) associated with traits of the individual livestock. Processing the real-time images may include developing a depth image (e.g., any of the depth images 500, 600, 1900, 2300, 2500, 2600, 2700 described herein) from which the key points are extracted. The method 3100 may further include generating a point cloud image (e.g., any of the point cloud images 700, 1100, 1400, 2000 described herein) from the depth image and extracting the trait from the point cloud image.

At block 3140 the method 3100 includes determining a trait (e.g., any of the traits discussed herein) using the key points 524.

At block 3150 the method 3100 includes obtaining a baseline set of traits associated with the type of livestock. The baseline set of traits may be located in, by way of example, a look-up table stored in one of the host computer 314, the remote server 316, the local server 318, and/or the smart device 320. The baseline set of traits may include previously determined traits using the system 100 described herein or using conventional methods known in the art (e.g., manually measured).

At block 3160 the method 3100 includes generating an electronic file associated with the individual livestock (e.g., the cow 120) when the trait determined (or multiple traits determined) deviates from a corresponding one of the baseline set of traits by a predetermined amount. The electronic file may include an array of all traits determined by the electronic processor 322 and associated with the cow 120. The baseline set of traits may include aggregated data for the individual livestock collected during previous screenings by the system 100. The baseline set of traits may also be a set of traits associated with the type of livestock rather than the individual livestock, (e.g., a typical cow of Holstein Friesian type). The electronic file may include one or more digital tags as described herein.

The method 3100 may further include training the neural network 3000 to predict the current BCS based on the determined trait. As described herein the determined trait may be multiple traits, including all of the determined traits described herein.

The method 3100 may further include detecting a body part of the individual livestock (e.g., the cow 120) using pattern detection of the real-time images. For example, the method 3100 may include detecting the rump of the cow 120 using the algorithm 400 described herein.

The method 3100 may include synchronizing the set of cameras 114 upon detecting the body part to capture the synchronized set of frames as described herein. The synchronized set of frames may include real-time images from a top view or side view perspective (e.g., real-time images captured by the top-view camera 114t and/or the side-view camera 114s).

The method 3100 may include receiving identification data from the RFID reader 110.

The system described herein can be used to supplement phenotypic data used in linear trait genetic evaluations. Furthermore, all cows in the herd can be measured more frequently, providing dairy producers with more timely, detailed information for breeding and culling decisions. Additional traits may be analyzed upon request with additional programming, because the system already has captured 3D images of the cattle.

Benefits associated with the system described herein include improvements to point cloud image analysis for livestock trait determination. Further, the system described herein enables more efficient and less subjective herd management.

The methods described herein utilize principles of geometry to objectively measure traits that have historically been measured subjectively. Additionally, the system as described herein provides daily indicators of energy reserves and mobility. The energy reserve score provides an indication of energy reserve level for cows throughout their lactation. At the individual cow level, this information can be used to assist with breeding, grouping, and management decisions. Aggregated data can be used to evaluate nutrition and transition cow decisions for more precise nutritional management. Three mobility metrics are calculated: back arch (BA), tracking up (TU), and swing out (SO). Each of these metrics are determined for individual cows and aggregated. Outliers may be determined based on group analysis for a herd of cows. The system and methods described herein provide more objective mobility measurements than subjective locomotion scores. For both energy reserve and mobility metrics, alerts can be provided when cows deviate from their corresponding baseline, providing the manager with notifications of animals that may need special attention.

The system and methods as described herein provide farm managers and other interested individuals with valuable insights derived from objective measurements, enabling data-driven decision-making processes. This empowers managers to implement targeted interventions and strategies to improve herd performance and overall farm profitability.

In the foregoing specification, specific examples have been described. However, one of ordinary skill in the art appreciates that various modifications and changes can be made without departing from the scope of the claimed subject matter. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Additionally, unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations, for example, collectively. To reiterate, those electronic processors and processing may be distributed.

Systems, methods, and devices in accordance with the present disclosure may take any one or more of the following configurations.

Clause 1. A system for evaluating cattle conformation, the system comprising: a set of cameras configured to capture real-time images of a type of livestock passing by the set of cameras; and an electronic processor communicatively connected to the set of cameras and configured to: receive identification data associated with an individual livestock; process the real-time images to extract key points of the individual livestock; determine a trait of the individual livestock using the key points; obtain a baseline set of traits associated with the type of livestock; and generate an electronic file associated with the individual livestock when the trait determined deviates from a corresponding one of the baseline set of traits by a predetermined amount.

Clause 2. The system of clause 1, wherein processing the real-time images further comprises producing a depth image from which the key points are extracted.

Clause 3. The system of any preceding clause, further comprising a neural network, wherein the electronic processor is further configured to provide the trait of the individual livestock or the real-time images as an input to the neural network and wherein the baseline set of traits includes a baseline body condition score.

Clause 4. The system of any preceding clause, wherein the type of livestock is dairy cows.

Clause 5. The system of any of clauses 3 or 4, wherein the neural network is a back propagation neural network.

Clause 6. The system of any of clauses 3-5, wherein the neural network is configured to predict a current body condition score for the livestock based on the input.

Clause 7. The system of any of clauses 3-6, wherein the electronic processor is further configured to train the neural network to predict the current body condition score based on training data including predetermined body condition scores.

Clause 8. They system of any of clauses 3-7, wherein the electronic processor is further configured to generate the electronic file when the current body condition score deviates from the baseline body condition score.

Clause 9. The system of any of clauses 3-8, wherein the electronic file is an array of all traits determined by the electronic processor and associated with the individual livestock.

Clause 10. The system of any preceding clause, wherein the key points include a left pin, a right pin, a left hook, a right hook, and a spine point, and wherein the traits include a left sacral ligament curvature that intersects the spine point and the left hook, a right sacral ligament curvature that intersects the spine point and the right hook, a spine curvature that intersects the spine point, and a thurl curvature that intersects one of the left pin or the right pin and a corresponding one of the left hook or the right hook.

Clause 11. The system of any preceding clause, wherein the electronic processor is configured to detect a rump of the individual livestock using pattern detection on the real-time images.

Clause 12. The system of any preceding clause, wherein the electronic processor is configured to synchronize the set of cameras upon detecting the rump to capture a synchronized set of frames including real-time images captured from different cameras.

Clause 13. The system of any preceding clause, wherein the electronic processor is configured to store a subset of the synchronized set of frames to define a constant rate video.

Clause 14. The system of clause 13, wherein the electronic processor is configured to attach the identification data to the constant rate video.

Clause 15. The system of any of clauses 13 or 14, wherein the electronic processor is configured to analyze the constant rate video to determine a depth image.

Clause 16. The system of any preceding clause, wherein the electronic processor is configured to convert the real-time images into a point cloud.

Clause 17. The system of any preceding clause, wherein the electronic processor is configured to obtain a two-dimensional image of the livestock from the point cloud.

Clause 18. The system of clause 17, wherein the electronic processor is configured to calculate the trait from the two-dimensional image, the trait selected from a group consisting of rump angle, rump width, stature, dairy form, hoof distance, foot angle, rear udder height, udder depth, rear udder width, teat length, udder tilt, udder cleft, teat distance, teat diameter, leg swing out, udder attachment angle, body depth, strength, wither angle, back arch, tracking up distance, left radius of curvature, spine radius of curvature, thurl radius of curvature, hook radius of curvature, pin radius of curvature, body condition score.

Clause 19. The system of clause 18, wherein the dairy form includes a spring of rib, a wither angle, and an udder angle.

Clause 20. The system of clause 1, further comprising a gate configured to move between an open position and a closed position.

Clause 21. The system of clause 20, wherein the gate is in the closed position while the set cameras capture the real-time images.

Clause 22. The system of any of clauses 20 or 21, wherein the gate moves between the closed position and the open position when the trait determined is within a predetermined amount of the baseline set of traits.

Clause 23. The system of any preceding clause, wherein the electronic file comprises and/or is linked to all of the traits determined by the system and associated with the individual livestock.

Clause 24. The system of any preceding clause, further comprising an RFID reader configured to read a tag, including the identification data, attached to the livestock, and sending the identification data to the electronic processor.

Clause 25. A method of evaluating cattle conformation, the method comprising:
capturing real-time images with a set of cameras, the real-time images including a type of livestock passing by the set of cameras; receiving identification data associated with an individual livestock at an electronic processor; processing the real-time images to extract key points of the individual livestock; determining a trait of the individual livestock using the key points; obtaining a baseline set of traits associated with the type of livestock; and generating an electronic file associated with the individual livestock when the trait determined deviates from a corresponding one of the baseline set of traits by a predetermined amount.

Clause 26. The method of clause 25, further comprising producing a depth image from which the key points are extracted.

Clause 27. The method of clause 26, further comprising generating a point cloud image from the depth image and extracting the trait from the point cloud image.

Clause 28. The method of any of clauses 25-27, further comprising training a neural network to predict a current body condition score based on the trait.

Clause 29. The method of any of clauses 25-28, further comprising detecting a body part of the individual livestock using pattern detection of the real-time images.

Clause 30. The method of clause 29, further comprising synchronizing the set of cameras upon detecting the body part to capture a synchronized set of frames including real-time top view images and side view images.

Clause 31. The method of any of clauses 25-30, wherein receiving the identification data comprises receiving identification data from an RFID reader configured to read a tag including the identification data attached to the livestock.

Clause 32. A system for evaluating cattle conformation, the system comprising a set of cameras configured to capture real-time images of a type of livestock passing by the set of cameras; and an electronic processor communicatively connected to the set of cameras and configured to receive identification data associated with an individual livestock, process the real-time images to extract key points of the individual livestock, determine a trait of the individual livestock using the key points, obtain a baseline set of traits associated with the type of livestock; and generate a graphical user interface element illustrating with the individual livestock and graphical elements representing a deviation of the trait from a corresponding one of the baseline set of traits by a predetermined amount.

What is claimed is:

1. A system for evaluating cattle conformation, the system comprising:
a set of cameras configured to capture real-time images of a type of livestock passing by the set of cameras; and
an electronic processor communicatively connected to the set of cameras and configured to:
receive identification data associated with an individual livestock;
process the real-time images to extract key points of the individual livestock;
determine a trait of the individual livestock using the key points;
obtain a baseline set of traits associated with the type of livestock; and
generate an electronic file associated with the individual livestock when the trait determined deviates from a corresponding one of the baseline set of traits by a predetermined amount.

2. The system of claim 1, wherein processing the real-time images further comprises producing a depth image from which the key points are extracted.

3. The system of claim 1 further comprising a neural network, wherein the electronic processor is further configured to provide the trait of the individual livestock or the real-time images as an input to the neural network and wherein the baseline set of traits includes a baseline body condition score.

4. The system of claim 3, wherein the neural network is configured to predict a current body condition score for the livestock based on the input.

5. The system of claim 4, wherein the electronic processor is further configured to train the neural network to predict the current body condition score based on training data including predetermined body condition scores.

6. They system of claim 5, wherein the electronic processor is further configured to generate the electronic file when the current body condition score deviates from the baseline body condition score.

7. The system of claim 1, wherein the electronic file is an array of all traits determined by the electronic processor and associated with the individual livestock.

8. The system of claim 1, wherein the key points include a left pin, a right pin, a left hook, a right hook, and a spine point, and
wherein the traits include a left sacral ligament curvature that intersects the spine point and the left hook, a right sacral ligament curvature that intersects the spine point and the right hook, a spine curvature that intersects the spine point, and a thurl curvature that intersects one of the left pin or the right pin and a corresponding one of the left hook or the right hook.

9. The system of claim 1, wherein the electronic processor is configured to detect a rump of the individual livestock using pattern detection on the real-time images.

10. The system of claim 9, wherein the electronic processor is configured to synchronize the set of cameras upon detecting the rump to capture a synchronized set of frames including real-time images captured from different cameras.

11. The system of claim 10, wherein the electronic processor is configured to store a subset of the synchronized set of frames to define a constant rate video.

12. The system of claim 11, wherein the electronic processor is configured to analyze the constant rate video to determine a depth image.

13. The system of claim 1, wherein the electronic processor is configured to convert the real-time images into a point cloud.

14. The system of claim 13, wherein the electronic processor is configured to obtain a two-dimensional image of the livestock from the point cloud.

15. The system of claim 14, wherein the electronic processor is configured to calculate the trait from the two-dimensional image, the trait selected from a group consisting of rump angle, rump width, stature, dairy form, hoof distance, foot angle, rear udder height, udder depth, rear udder width, teat length, udder tilt, udder cleft, teat distance, teat diameter, leg swing out, udder attachment angle, body depth, strength, wither angle, back arch, tracking up distance, left radius of curvature, spine radius of curvature, thurl radius of curvature, hook radius of curvature, pin radius of curvature, body condition score.

16. The system of claim 15, wherein the dairy form includes a spring of rib, a wither angle, and an udder angle.

17. The system of claim 1, further comprising an RFID reader configured to read a tag, including the identification data, attached to the livestock, and sending the identification data to the electronic processor.

18. A method of evaluating cattle conformation, the method comprising:
capturing real-time images with a set of cameras, the real-time images including a type of livestock passing by the set of cameras;
receiving identification data associated with an individual livestock at an electronic processor;
processing the real-time images to extract key points of the individual livestock;
determining a trait of the individual livestock using the key points;
obtaining a baseline set of traits associated with the type of livestock; and
generating an electronic file associated with the individual livestock when the trait determined deviates from a corresponding one of the baseline set of traits by a predetermined amount.

19. The method of claim 18, further comprising:
producing a depth image from which the key points are extracted,
generating a point cloud image from the depth image and extracting the trait from the point cloud image, and
training a neural network to predict a current body condition score based on the trait.

20. A system for evaluating cattle conformation, the system comprising:
a set of cameras configured to capture real-time images of a type of livestock passing by the set of cameras; and
an electronic processor communicatively connected to the set of cameras and configured to:
receive identification data associated with an individual livestock;
process the real-time images to extract key points of the individual livestock;
determine a trait of the individual livestock using the key points;
obtain a baseline set of traits associated with the type of livestock; and
generate a graphical user interface element illustrating the individual livestock and graphical elements representing a deviation of the trait from a corresponding one of the baseline set of traits by a predetermined amount.
